(19) United States
(12) Patent Application Publication
(10) Pub. No.: US 2026/0209893 A1
(43) Pub. Date: Jul. 23, 2026

(54) MEDIUM STRENGTH 7xxx SERIES REGENERATED ALUMINUM ALLOY AND METHOD FOR PREPARING THE SAME

(71) Applicant: TAIWAN HODAKA TECHNOLOGY CO., LTD., Tainan City (TW)

(72) Inventors: Chune-Ching YOUNG, Tainan City (TW); Chun-Hsien CHIANG, Tainan City (TW); Yen-Hao CHEN, Tainan City (TW); Jen-Hao SONG, Tainan City (TW); Chun-Hung KO, Kaohsiung City (TW); Teng-Yang PAI, Kaohsiung City (TW)

(21) Appl. No.: 19/275,291

(22) Filed: Jul. 21, 2025

(30) Foreign Application Priority Data
Jan. 22, 2025 (TW) 114102840

(51) Int. Cl. C22C 1/02; B21C 23/00; B22D 21/00; C22C 1/03; C22C 21/10

(52) U.S. Cl. CPC C22C 1/026; B21C 23/002; B22D 21/007; C22C 1/03; C22C 21/10

(57) ABSTRACT

A method for preparing a medium strength 7xxx series regenerated aluminum alloy includes a raw material selection and composition design step, a purification and refining step, a melting step, an alloy composition conditioning step, and a casting step. A medium strength 7xxx series regenerated aluminum alloy prepared by the method is also provided.

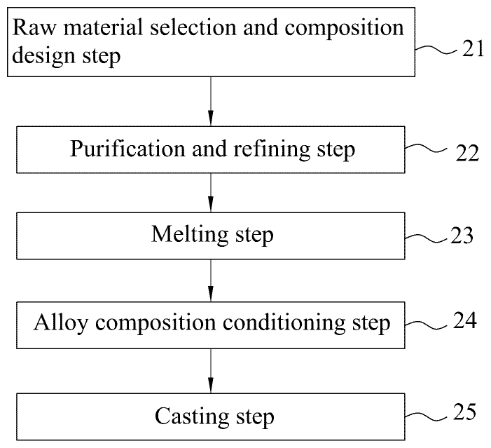

### CROSS-REFERENCE TO RELATED APPLICATION

This application claims priority to Taiwanese Invention patent application No. 114102840, filed on Jan. 22, 2025, the entire disclosure of which is incorporated by reference herein.

### FIELD

The present disclosure relates to a medium strength 7xxx series regenerated aluminum alloy and a method for preparing the same, and more particularly to a medium strength 7xxx series regenerated aluminum alloy with a relatively high amount of recycled aluminum alloys, and a method for preparing the same.

### BACKGROUND

Aluminum offers advantages such as low density and high strength. Aluminum alloys with various properties can be obtained by adding different alloying elements, and thus are widely used in different industries with growing demand. For instance, 5xxx series aluminum alloys, in which a main alloying element is magnesium, offer medium strength along with excellent weldability and corrosion resistance, and thus are commonly used in marine equipment, ships, automotive components, etc. 6xxx series aluminum alloys, in which main alloying elements are magnesium and silicon, provide excellent formability, medium-to-high strength, as well as corrosion resistance, and thus are frequently used in construction, transportation, electronics, household products, etc. 7xxx series aluminum alloys, in which main alloying elements are magnesium and zinc, may contain copper levels that are adjusted based on the end product requirements and are heat-treatable for enhanced strength. To be specific, high strength 7xxx series aluminum alloys are widely used in the aerospace industry, while medium strength 7xxx series aluminum alloys (typically T6 heat-treated 7xxx series aluminum alloys with an ultimate tensile strength (UTS) of less than 550 MPa and lower copper amount) are suitable for automotive structural materials, sporting goods, consumer electronics, etc.

Due to wide range of applications and the growing demand for aluminum alloys, recycling of aluminum alloy waste (i.e., recycled aluminum alloys) and use of the same have become a key goal in relevant technical fields. However, owing to the wide compositional variations of the recycled aluminum alloys, regenerated aluminum alloys are typically prepared using the recycled aluminum alloys from the same series, resulting in products of the regenerated aluminum alloys with the same series. In order to increase amounts of the recycled aluminum alloys in the regenerated aluminum alloys, the upper limits of the amount of the alloying elements in the products of the regenerated aluminum alloys have been relaxed. However, the aforesaid approach carries a risk of compromising the performance of the regenerated aluminum alloys.

In addition, recycling of the aluminum alloy waste varies in difficulty depending on applications thereof. For example, the 5xxx and 6xxx series aluminum alloys have relatively high market demand and have abundant sources of recycling. The high strength 7xxx series aluminum alloys, which are widely used in the aerospace industry, can easily establish a well-scaled recycling system through integration of upstream and downstream supply chains. However, the medium strength 7xxx series aluminum alloys face conventional challenges of low amounts of the recycled aluminum alloys in regenerated products thereof due to relatively dispersed applications thereof (such as the automotive structural materials, sporting goods, consumer electronics, etc.), resulting in a relatively low recycling rate and difficulty in sourcing the recycled aluminum alloys with similar alloying elements.

In view of the aforesaid, there is still a need to develop a method for preparing a medium strength 7xxx series regenerated aluminum alloy which has a relatively high amount of recycled aluminum alloys.

### SUMMARY

Therefore, an object of the present disclosure is to provide a medium strength 7xxx series regenerated aluminum alloy and a method for preparing the same, which can alleviate at least one of the drawbacks of the prior art.

According to one aspect of the present disclosure, the method for preparing a medium strength 7xxx series regenerated aluminum alloy includes:
a raw material selection and composition design step of providing a primary pure aluminum ingot, a first recycled aluminum alloy, a second recycled aluminum alloy, and a third recycled aluminum alloy, each of the first recycled aluminum alloy and the second recycled aluminum alloy being selected from the group consisting of a 5xxx series recycled aluminum alloy and a 6xxx series recycled aluminum alloy, the third recycled aluminum alloy being selected from the group consisting of a 5xxx series recycled aluminum alloy, a 6xxx series recycled aluminum alloy, a 1xxx series recycled aluminum alloy, a 7xxx series recycled aluminum alloy, and a combination thereof,
wherein each of the first recycled aluminum alloy, the second recycled aluminum alloy, and the third recycled aluminum alloy contains target alloying elements, and
wherein amounts of the first recycled aluminum alloy, the second recycled aluminum alloy, the third recycled aluminum alloy, and the primary pure aluminum ingot are calculated based on a predetermined amount of a respective one of the target alloying elements in a medium strength 7xxx series aluminum alloy which has a grade same as a grade of the medium strength 7xxx series regenerated aluminum alloy;
a purification and refining step of purifying and refining at least one of the first recycled aluminum alloy, the second recycled aluminum alloy, and the third recycled aluminum alloy containing the target alloying elements provided in the raw material selection and composition design step to remove a portion of at least one of the target alloying elements from the at least one of the first recycled aluminum alloy, the second recycled aluminum alloy, and the third recycled aluminum alloy based on the predetermined amount of the respective one of the target alloying elements in the medium strength 7xxx series aluminum alloy, so as to obtain a refined recycled aluminum material containing the target alloying elements, a remaining portion of the first recycled aluminum alloy, the second recycled aluminum alloy, and the third recycled aluminum alloy being an unrefined recycled aluminum material that contains the target alloying elements after the at least one of the first recycled aluminum alloy, the second recycled aluminum alloy, and the third recycled aluminum alloy has undergone the purification and refining step;
a melting step of melting the primary pure aluminum ingot provided in the raw material selection and composition design step, the unrefined recycled aluminum material, and the refined recycled aluminum material obtained in the purification and refining step into an aluminum alloy melt containing the target alloying elements, an amount of a respective one of the target alloying elements in the aluminum alloy melt being not greater than the predetermined amount of the respective one of the target alloying elements in the medium strength 7xxx series aluminum alloy;
an alloy composition conditioning step of adjusting the amount of the respective one of the target alloying elements in the aluminum alloy melt obtained in the melting step to fall within the predetermined amount of the respective one of the target alloying elements in the medium strength 7xxx series aluminum alloy, so as to obtain a conditioned aluminum alloy melt, the first recycled aluminum alloy, the second recycled aluminum alloy, and the third recycled aluminum alloy in the conditioned aluminum alloy melt being present in an amount not lower than 75 wt %, based on a total weight of the conditioned aluminum alloy melt as 100 wt %; and
a casting step of subjecting the conditioned aluminum alloy melt obtained in the alloy composition conditioning step to a casting treatment, so as to obtain the medium strength 7xxx series regenerated aluminum alloy containing the predetermined amount of the respective one of the target alloying elements.

According to another aspect of the present disclosure, the medium strength 7xxx series regenerated aluminum alloy prepared by the aforesaid method includes a first recycled aluminum alloy, a second recycled aluminum alloy, and a third recycled aluminum alloy present in an amount not lower than 75 wt %, based on a total weight of the medium strength 7xxx series regenerated aluminum alloy as 100 wt %. The medium strength 7xxx series regenerated aluminum alloy has an ultimate tensile strength (UTS) ranging from 350 MPa to 550 MPa, a tensile yield strength (TYS) ranging from 300 MPa to 500 MPa, and an elongation (EL) greater than 10% at T6 heat treatment condition.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The sole FIGURE of this application is a flow chat illustrating an embodiment of a method for preparing a medium strength 7xxx series regenerated aluminum alloy according to the disclosure.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

Referring to the FIGURE, a method for preparing a medium strength 7xxx series regenerated aluminum alloy according to the present disclosure includes a raw material selection and composition design step 21, a purification and refining step 22, a melting step 23, an alloy composition conditioning step 24, and a casting step 25 in sequence.

In the raw material selection and composition design step 21, a primary pure aluminum ingot, a first recycled aluminum alloy, a second recycled aluminum alloy, and a third recycled aluminum alloy are provided. To be specific, each of the first recycled aluminum alloy and the second recycled aluminum alloy is selected from the group consisting of a 5xxx series recycled aluminum alloy and a 6xxx series recycled aluminum alloy. The third recycled aluminum alloy is selected from the group consisting of a 5xxx series recycled aluminum alloy, a 6xxx series recycled aluminum alloy, a 1xxx series recycled aluminum alloy, a 7xxx series recycled aluminum alloy, and combinations thereof. Each of the first recycled aluminum alloy, the second recycled aluminum alloy, and the third recycled aluminum alloy contains target alloying elements. Moreover, amounts of the first recycled aluminum alloy, the second recycled aluminum alloy, the third recycled aluminum alloy, and the primary pure aluminum ingot are calculated based on a predetermined amount of a respective one of the target alloying elements in a medium strength 7xxx series aluminum alloy which has a grade same as a grade of the medium strength 7xxx series regenerated aluminum alloy.

In the purification and refining step 22, at least one of the first recycled aluminum alloy, the second recycled aluminum alloy, and the third recycled aluminum alloy containing the target alloying elements provided in the raw material selection and composition design step 21 is purified and refined to remove a portion of at least one of the target alloying elements from the at least one of the first recycled aluminum alloy, the second recycled aluminum alloy, and the third recycled aluminum alloy based on the predetermined amount of the respective one of the target alloying elements in the medium strength 7xxx series aluminum alloy, so as to obtain a refined recycled aluminum material containing the target alloying elements. In addition, a remaining portion of the first recycled aluminum alloy, the second recycled aluminum alloy, and the third recycled aluminum alloy is an unrefined recycled aluminum material that contains the target alloying elements after the at least one of the first recycled aluminum alloy, the second recycled aluminum alloy, and the third recycled aluminum alloy has undergone the purification and refining step 22.

In the melting step 23, the primary pure aluminum ingot provided in the raw material selection and composition design step 21, the unrefined recycled aluminum material, and the refined recycled aluminum material obtained in the purification and refining step 22 are melted into an aluminum alloy melt containing the target alloying elements. To be specific, an amount of a respective one of the target alloying elements in the aluminum alloy melt is not greater than the predetermined amount of the respective one of the target alloying elements in the medium strength 7xxx series aluminum alloy.

In the alloy composition conditioning step 24, the amount of the respective one of the target alloying elements in the aluminum alloy melt obtained in the melting step 23 is adjusted to fall within the predetermined amount of the respective one of the target alloying elements in the medium strength 7xxx series aluminum alloy, so as to obtain a conditioned aluminum alloy melt. To be specific, by virtue of adding a target alloying element selected from the group consisting of pure magnesium (Mg), pure zinc (Zn), pure copper (Cu), an iron (Fe) cake, a manganese (Mn) cake, a titanium (Ti) cake, a chromium (Cr) cake, a zirconium (Zr) master alloy, and combinations thereof into the aluminum alloy melt, the amount of the respective one of the target alloying elements in the aluminum alloy melt is adjusted, so as to obtain the conditioned aluminum alloy melt. Furthermore, the first recycled aluminum alloy, the second recycled aluminum alloy, and the third recycled aluminum alloy in the conditioned aluminum alloy melt are present in an amount not lower than 75 wt %, based on a total weight of the conditioned aluminum alloy melt as 100 wt %.

In the casting step 25, the conditioned aluminum alloy melt obtained in the alloy composition conditioning step 24 is subjected to a casting treatment, so as to obtain the medium strength 7xxx series regenerated aluminum alloy containing the predetermined amount of the respective one of the target alloying elements. To be specific, the medium strength 7xxx series regenerated aluminum alloy has a relatively high amount of recycled aluminum alloys.

Each of the raw material selection and composition design step 21, the purification and refining step 22, the alloy composition conditioning step 24, and the casting step 25 are described in detail hereinafter.

### <Raw Material Selection and Composition Design Step 21>

In certain embodiments, the third recycled aluminum alloy is selected from the group consisting of a 1xxx series recycled aluminum alloy, a 7xxx series recycled aluminum alloy, and a combination thereof.

To be specific, the 5xxx series recycled aluminum alloy is selected from the group consisting of a 5050 recycled aluminum alloy, a 5051 recycled aluminum alloy, a 5056 recycled aluminum alloy, and combinations thereof. The 6xxx series recycled aluminum alloy is selected from the group consisting of a 6060 recycled aluminum alloy, a 6061 recycled aluminum alloy, a 6063 recycled aluminum alloy, and combinations thereof. The 1xxx series recycled aluminum alloy is selected from the group consisting of a 1050 recycled aluminum alloy, a 1070 recycled aluminum alloy, a 1100 recycled aluminum alloy, and combinations thereof. The 7xxx series recycled aluminum alloy is selected from the group consisting of a 7050 recycled aluminum alloy, a 7150 recycled aluminum alloy, an recycled aluminum alloy having the grade same as the grade of the medium strength 7xxx series regenerated aluminum alloy obtained in the casting step 25, and combinations thereof. In certain embodiments, the recycled aluminum alloy having the grade same as the grade of the medium strength 7xxx series regenerated aluminum alloy obtained in the casting step 25 is internal scrap.

It should be noted that due to variations in recycling sources, the first recycled aluminum alloy, the second recycled aluminum alloy, and the third recycled aluminum alloy may be a specific aluminum alloy grade or a mixture of different aluminum alloy grades and/or components. According to the present disclosure, a grade of the first recycled aluminum alloy, the second recycled aluminum alloy, and the third recycled aluminum alloy may refer either to the specific aluminum alloy grade or the mixture of the specific aluminum alloy grade serving as a primary component (with an amount greater than 50%) doped with a different aluminum alloy grade and/or component.

### <Purification and Refining Step 22>

According to the present disclosure, by virtue of comparing an amount of a respective one of the target alloying elements in the first recycled aluminum alloy, the second recycled aluminum alloy, the third recycled aluminum alloy, and the primary pure aluminum ingot provided in the raw material selection and composition design step 21 with the predetermined amount of the respective one of the target alloying elements in the medium strength 7xxx series aluminum alloy, the at least one of the first recycled aluminum alloy, the second recycled aluminum alloy, and the third recycled aluminum alloy containing the target alloying elements and non-target alloying elements (if any) provided in the raw material selection and composition design step 21 is selected for purification and refinement to remove the portion of the at least one of the target alloying elements with an excessive deviation from the at least one of the first recycled aluminum alloy, the second recycled aluminum alloy, and the third recycled aluminum alloy and/or to remove the non-target alloying elements that are unnecessary from the at least one of the first recycled aluminum alloy, the second recycled aluminum alloy, and the third recycled aluminum alloy, so that an amount of a respective one of the target alloying elements in the first recycled aluminum alloy, the second recycled aluminum alloy, and the third recycled aluminum alloy may be pre-adjusted to be not greater than the predetermined amount of the respective one of the target alloying elements in the medium strength 7xxx series aluminum alloy or to fall within a predetermined deviation range compared to the predetermined amount of the respective one of the target alloying elements in the medium strength 7xxx series aluminum alloy.

According to the present disclosure, the purification and refining step 22 may be selected from the group consisting of a boron treatment, a segregation purification treatment, and a combination thereof.

In certain embodiments, the boron treatment may be carried out using techniques well-known to those skilled in the art. In brief, the boron treatment includes melting the at least one of the first recycled aluminum alloy, the second recycled aluminum alloy, and the third recycled aluminum alloy containing the target alloying elements and non-target alloying elements (if any) into an aluminum melt, and then adding a boron master alloy to allow boron in the boron master alloy to react with titanium (Ti), zirconium (Zr), vanadium (V), and chromium (Cr) in the aluminum melt to form a boride precipitate; followed by separating the boride precipitate to remove titanium (Ti), zirconium (Zr), vanadium (V), and chromium (Cr) from the aluminum melt, so as to obtain the refined recycled aluminum material.

In certain embodiments, the segregation purification treatment may be carried out using techniques well-known to those skilled in the art. In brief, the segregation purification treatment includes melting the at least one of the first recycled aluminum alloy, the second recycled aluminum alloy, and the third recycled aluminum alloy containing the target alloying elements and non-target alloying elements (if any) into the aluminum melt, followed by allowing the aluminum melt to solidify slowly. During solidification, the non-target alloying elements (if any) and a portion of the target alloying elements (such as silicon (Si), iron (Fe), magnesium (Mg), copper (Cu), etc.) segregate and diffuse into a liquid phase, so as to obtain the refined recycled aluminum material containing a relatively pure aluminum crystal.

### <Alloy Composition Conditioning Step 24>

According to the present disclosure, the conditioned aluminum alloy melt obtained in the alloy composition conditioning step 24 includes, based on the total weight of the conditioned aluminum alloy melt as 100 wt %: not greater than 0.15 wt % of silicon; not greater than 0.20 wt % of iron; not greater than 0.4 wt % of copper; not greater than 0.30 wt % of manganese; 0.5 wt % to 2.0 wt % of magnesium; 4.0 wt % to 8.0 wt % of zinc; not greater than 0.2 wt % of chromium; not greater than 0.06 wt % of titanium; not greater than 0.25 wt % of zirconium; and aluminum which makes up the balance.

### <Casting Step 25>

In certain embodiments, the conditioned aluminum alloy melt obtained in the alloy composition conditioning step 24 is further subjected to an extrusion treatment after the casting treatment. To be specific, the conditioned aluminum alloy melt obtained in the alloy composition conditioning step 24 is subjected to the casting treatment so as to obtain the medium strength 7xxx series regenerated aluminum alloy in a form of a cast rod, followed by conducting the extrusion treatment so as to obtain the medium strength 7xxx series regenerated aluminum alloy serving as an extrusion part.

According to the present disclosure, a trimmed material generated during the casting treatment and/or the extrusion treatment may be recovered and then added to the first recycled aluminum alloy, the second recycled aluminum alloy, the third recycled aluminum alloy, and the primary pure aluminum ingot provided in the raw material selection and composition design step 21 or the aluminum alloy melt obtained in the melting step 23 for reuse.

The present disclosure also provides a medium strength 7xxx series regenerated aluminum alloy prepared by the aforesaid method, which includes the first recycled aluminum alloy, the second recycled aluminum alloy, and the third recycled aluminum alloy present in an amount not lower than 75 wt %, based on a total weight of the medium strength 7xxx series regenerated aluminum alloy as 100 wt %, and which has a relatively high amount of recycled aluminum alloys.

According to the present disclosure, the medium strength 7xxx series regenerated aluminum alloy includes, based on the total weight of the medium strength 7xxx series regenerated aluminum alloy as 100 wt %: not greater than 0.15 wt % of silicon; not greater than 0.20 wt % of iron; not greater than 0.4 wt % of copper; not greater than 0.30 wt % of manganese; 0.5 wt % to 2.0 wt % of magnesium; 4.0 wt % to 8.0 wt % of zinc; not greater than 0.2 wt % of chromium; not greater than 0.06 wt % of titanium; not greater than 0.25 wt % of zirconium; and aluminum which makes up the balance.

According to the present disclosure, the medium strength 7xxx series regenerated aluminum alloy has an ultimate tensile strength (UTS) ranging from 350 MPa to 550 MPa, a tensile yield strength (TYS) ranging from 300 MPa to 500 MPa, and an elongation (EL) greater than 10% at T6 heat treatment condition.

In certain embodiments, the medium strength 7xxx series regenerated aluminum alloy includes the first recycled aluminum alloy, the second recycled aluminum alloy, and the third recycled aluminum alloy present in an amount not lower than 80 wt %, based on the total weight of the medium strength 7xxx series regenerated aluminum alloy as 100 wt %. Each of the first recycled aluminum alloy and the second recycled aluminum alloy serves as a primary component and is selected from the group consisting of the 5xxx series aluminum alloy and the 6xxx series aluminum alloy. That is, in certain embodiments, the first recycled aluminum alloy and the second recycled aluminum alloy are present in a total amount not lower than 40 wt %, based on a total weight of the first recycled aluminum alloy, the second recycled aluminum alloy, and the third recycled aluminum alloy as 100 wt %. In other embodiments, the first recycled aluminum alloy and the second recycled aluminum alloy are present in a total amount ranging from 40 wt % to 50 wt %, based on the total weight of the first recycled aluminum alloy, the second recycled aluminum alloy, and the third recycled aluminum alloy as 100 wt %.

An amount of a respective one of the target alloying elements in each of the medium strength 7xxx series regenerated aluminum alloy prepared by the aforesaid method (hereinafter abbreviated as HR7xxx) and several commercially available medium strength aluminum alloys with different grades (i.e., AA 7005, AA 7046, and AA 7021) is listed in Table 1 below.

TABLE 1

| 7××× series | Si | Fe | Cu | Mn | Mg | Zn | Cr | Ti | Zr |
|---|---|---|---|---|---|---|---|---|---|
| aluminum alloy | Unit: wt % | | | | | | | | |
| HR7××× | ≤0.15 | ≤0.20 | ≤0.4 | ≤0.30 | 0.5-2.0 | 4.0-8.0 | ≤0.2 | ≤0.06 | ≤0.25 |
| AA 7005 | ≤0.35 | ≤0.40 | ≤0.10 | 0.20-0.7 | 1.0-1.8 | 4.0-5.0 | 0.06-0.20 | 0.01-0.06 | 0.08-0.20 |
| AA 7046 | ≤0.20 | ≤0.40 | ≤0.25 | ≤0.30 | 1.0-1.6 | 6.6-7.6 | ≤0.20 | ≤0.06 | 0.10-0.18 |
| AA 7021 | ≤0.25 | ≤0.40 | ≤0.25 | ≤0.10 | 1.2-1.8 | 5.0-6.0 | ≤0.05 | ≤0.10 | 0.08-0.18 |
| AA 7030 | ≤0.20 | ≤0.30 | 0.20-0.40 | ≤0.05 | 1.0-1.5 | 4.8-5.9 | ≤0.04 | ≤0.03 | ≤0.03 |

Referring to Table 1, the medium strength 7xxx series regenerated aluminum alloy (i.e., HR7xxx) may meet a predetermined low amount of copper (i.e., Cu≤0.40 wt %) in typical medium strength aluminum alloys (i.e., the several commercially available medium strength aluminum alloys with the different grades).

The disclosure will be further described by way of the following examples. However, it should be understood that the following examples are solely intended for the purpose of illustration and should not be construed as limiting the disclosure in practice.

### EXAMPLES

### Example 1-AA 7005 Regenerated Aluminum Alloy (EX1-AA 7005)

A method for preparing a medium strength AA 7005 regenerated aluminum alloy of EX1 (hereinafter abbreviated as EX1-AA 7005, AA 7005 being a designation under the Aluminum Association (AA) standard) includes the following steps: a raw material selection and composition design step 21; a purification and refining step 22; a melting step 23; an alloy composition conditioning step 24; and a casting step 25.

### <Raw Material Selection and Composition Design Step 21>

First, approximately 18.4 wt % of a primary pure aluminum ingot, 14.3 wt % of an AA 5051 recycled aluminum alloy (AA 5051 being a designation under the Aluminum Association (AA) standard, serving as a 5xxx series recycled aluminum alloy and containing target alloying elements as shown in Table 2), 29.5 wt % of an AA 6063 recycled aluminum alloy (AA 6063 being a designation under the Aluminum Association (AA) standard, serving as a 6xxx series recycled aluminum alloy and containing target alloying elements as shown in Table 2), 28.7 wt % of an AA 7005 recycled aluminum alloy (AA 7005 being a designation under the Aluminum Association (AA) standard, serving as a 7xxx recycled series aluminum alloy and containing target alloying elements as shown in Table 2), and 9.1 wt % of an AA 7050 recycled aluminum alloy (AA 7050 being a designation under the Aluminum Association (AA) standard, serving as a 7xxx series recycled aluminum alloy and containing target alloying elements as shown in Table 2) were provided.

To be specific, the AA 5051 recycled aluminum alloy was a mixture of the AA 5051 recycled aluminum alloys (serving as a primary component) and a recycled aluminum alloy with a different grade and/or a component which is differ from the AA 5051 recycled aluminum alloys. The AA 6063 recycled aluminum alloy was a mixture of the AA 6063 recycled aluminum alloys (serving as a primary component) and a recycled aluminum alloy with a different grade and/or a component which is differ from the AA 6063 recycled aluminum alloys. The AA 7050 recycled aluminum alloy was a mixture of the AA 7050 recycled aluminum alloys (serving as a primary component) and a recycled aluminum alloy with a different grade and/or a component which is differ from the AA 7050 recycled aluminum alloys. The AA 7005 recycled aluminum alloy did not contain other recycled aluminum alloy grades or components.

In addition, the aforesaid amount for a respective one of the primary pure aluminum ingot, the AA 5051 recycled aluminum alloy, the AA 6063 recycled aluminum alloy, the AA 7005 recycled aluminum alloy, and the AA 7050 recycled aluminum alloy was calculated based on a predetermined amount of a respective one of the target alloying elements in an AA 7005 aluminum alloy.

### <Purification and Refining Step 22>

29.5 wt % of the AA 6063 recycled aluminum alloy and 9.1 wt % of the AA 7050 recycled aluminum alloy, which contained the target alloying elements and were provided in the raw material selection and composition design step 21, were purified and refined to remove a portion of at least one of the target alloying elements from the AA 6063 recycled aluminum alloy and the AA 7050 recycled aluminum alloy based on the predetermined amount of the respective one of the target alloying elements in the AA 7005 aluminum alloy, so as to obtain a refined AA 6063 recycled aluminum alloy and a refined AA 7050 recycled aluminum alloy which contained the target alloying elements and collectively serving as a refined recycled aluminum material. In addition, after the AA 6063 and AA 7050 recycled aluminum alloys has undergone the purification and refining step 22, the AA 5051 and AA 7005 recycled aluminum alloys collectively served as an unrefined recycled aluminum material.

### <Melting Step 23>

Approximately 18.4 wt % of the primary pure aluminum ingot, the unrefined recycled aluminum material, and the refined recycled aluminum material obtained in the purification and refining step 22 were melted into an aluminum alloy melt containing the target alloying elements. An amount of a respective one of the target alloying elements in the aluminum alloy melt was not greater than the predetermined amount of the respective one of the target alloying elements in the AA 7005 aluminum alloy.

### <Alloy Composition Conditioning Step 24>

By virtue of adding a trace amount of an target alloying element selected from the group consisting of pure magnesium (Mg), pure zinc (Zn), pure copper (Cu), an iron (Fe) cake, a manganese (Mn) cake, a titanium (Ti) cake, a chromium (Cr) cake, a zirconium (Zr) master alloy, and combinations thereof into the aluminum alloy melt, the amount of the respective one of the target alloying elements in the aluminum alloy melt obtained in the melting step 23 was adjusted to fall within the predetermined amount of the respective one of the target alloying elements in the AA 7005 aluminum alloy, so as to obtain a conditioned aluminum alloy melt.

It should be noted that the trace amount of the target alloying element added in the alloy composition conditioning step 24 and approximately 18.4 wt % of the primary pure aluminum ingot provided in the raw material selection and composition design step 21 were present in a total amount of 18.4 wt %, based on a total weight of the conditioned aluminum alloy melt as 100 wt %.

### <Casting Step 25>

The conditioned aluminum alloy melt obtained in the alloy composition conditioning step 24 was subjected to a casting treatment to form an aluminum cast rod with a diameter of 7 inch, followed by subjecting the aluminum cast rod to a homogenization treatment, so as to obtain a homogenized aluminum cast rod. Then, the homogenized aluminum cast rod was subjected to an extrusion treatment at an extrusion ratio of 25:1, so as to obtain the EX1-AA 7005. To be specific, the first recycled aluminum alloy, the second recycled aluminum alloy, and the third recycled aluminum alloy, which included the AA 5051 recycled aluminum alloy, the AA 6063 aluminum recycled alloy, the AA 7005 recycled aluminum alloy, and the AA 7050 recycled aluminum alloy, were present in an amount of 81.6 wt %, based on a total weight of the EX1-AA 7005 as 100 wt %.

The types and amounts of materials used for preparing the EX1-AA 7005 based on the total weight of the EX1-AA 7005 as 100 wt %, and the amounts of a respective one of the target alloying elements in each of the materials and the EX1-AA 7005 based on a total weight of each of the materials and the EX1-AA 7005 as 100 wt %, respectively, are summarized in Table 2 below.

### Example 2-AA 7046 Regenerated Aluminum Alloy (EX2-AA 7046)

The procedures for preparing a medium strength AA 7046 regenerated aluminum alloy of EX2 (hereinafter abbreviated as EX2-AA 7046, AA 7046 being a designation under the Aluminum Association (AA) standard) were similar to those of the EX1-AA 7005, except that the materials and the amounts thereof for preparing the EX2-AA 7046, and the amounts of the respective one of the target alloying elements in each of the materials and the EX2-AA 7046 based on a total weight of each of the materials and the EX2-AA 7046 as 100 wt %, respectively, were varied as shown in Table 3 below. To be specific, in the raw material selection and composition design step 21, 28.7 wt % of the AA 7005 recycled aluminum alloy was replaced with 29.1 wt % of the AA 7046 recycled aluminum alloy which did not contain other recycled aluminum alloy grades or components (AA 7046 being a designation under the Aluminum Association (AA) standard), and an amount of a respective one of the materials provided in this step was calculated based on a predetermined amount of a respective one of the target alloying elements in an AA 7046 aluminum alloy. The first recycled aluminum alloy, the second recycled aluminum alloy, and the third recycled aluminum alloy, which included the AA 5051 recycled aluminum alloy, the AA 6063 aluminum recycled alloy, the AA 7046 recycled aluminum alloy, and the AA 7050 recycled aluminum alloy, were present in an amount of 94.9 wt %, based on a total weight of the EX2-AA 7046 as 100 wt %.

### Comparative Example 1-AA 7021 Regenerated Aluminum Alloy (CE1-AA 7021)

Briefly, a method for preparing a medium strength AA 7021 regenerated aluminum alloy of CE1 (hereinafter abbreviated as CE1-AA 7021, AA 7021 being a designation under the Aluminum Association (AA) standard) includes the following steps: a raw material selection and composition design step 21, a melting step 23; an alloy composition conditioning step 24; and a casting step 25.

### <Raw Material Selection and Composition Design Step 21>

First, approximately 55.4 wt % of a primary pure aluminum ingot and 44.6 wt % of an AA 7021 recycled aluminum alloy (containing target alloying elements such as silicon (Si), iron (Fe), copper (Cu), manganese (Mn), magnesium (Mg), zinc (Zn), chromium (Cr), titanium (Ti), and zirconium (Zr)) were provided. To be specific, the AA 7021 recycled aluminum alloy did not contain other recycled aluminum alloy grades or components.

In addition, the aforesaid amount of a respective one of the primary pure aluminum ingot and the AA 7021 recycled aluminum alloy was calculated based on a predetermined amount of a respective one of the target alloying elements in an AA 7021 aluminum alloy.

### <Melting Step 23>

Approximately 55.4 wt % of the primary pure aluminum ingot and 44.6 wt % of the AA 7021 recycled aluminum alloy provided in the raw material selection and composition design step 21 were melted into an aluminum alloy melt containing the target alloying elements. An amount of a respective one of the target alloying elements in the aluminum alloy melt was not greater than the predetermined amount of the respective one of the target alloying elements in the AA 7021 aluminum alloy.

### <Alloy Composition Conditioning Step 24>

By virtue of adding a trace amount of a target alloying element selected from the group consisting of pure magnesium (Mg), pure zinc (Zn), pure copper (Cu), an iron (Fe) cake, a manganese (Mn) cake, a titanium (Ti) cake, a chromium (Cr) cake, a zirconium (Zr) master alloy, and combinations thereof into the aluminum alloy melt, the amount of the respective one of the target alloying elements in the aluminum alloy melt obtained in the melting step 23 was adjusted to fall within the predetermined amount of the respective one of the target alloying elements in the AA 7021 aluminum alloy, so as to obtain a conditioned aluminum alloy melt.

It should be noted that the trace amount of the target alloying element added in the alloy composition conditioning step 24 and approximately 55.4 wt % of the primary pure aluminum ingot provided in the raw material selection and composition design step 21 were present in a total amount of 55.4 wt %, based on a total weight of the conditioned aluminum alloy melt as 100 wt %.

### <Casting Step 25>

The conditioned aluminum alloy melt obtained in the alloy composition conditioning step 24 was subjected to a casting treatment to form an aluminum cast rod with a diameter of 7 inch, followed by subjecting the aluminum cast rod to a homogenization treatment, so as to obtain a homogenized aluminum cast rod. Then, the homogenized aluminum cast rod was subjected to an extrusion treatment at an extrusion ratio of 25:1, so as to obtain the CE1-AA 7021. To be specific, the AA 7021 recycled aluminum alloy was present in an amount of 44.6 wt %, based on a total weight of the CE1-AA 7021 as 100 wt %.

The types and amounts of materials used for preparing the CE1-AA 7021 based on the total weight of the CE1-AA 7021 as 100 wt % are summarized in Table 4 below.

### Comparative Example 2-AA 7026 Regenerated Aluminum Alloy (CE2-AA 7026)

The procedures for preparing a medium strength AA 7026 regenerated aluminum alloy of CE2 (hereinafter abbreviated as CE2-AA 7026, AA 7026 being a designation under the Aluminum Association (AA) standard) were similar to those of the CE1-AA 7021, except that the materials and the amounts thereof for preparing the CE2-AA 7026 were varied as shown in Table 4 below. To be specific, in the raw material selection and composition design step 21, 44.6 wt % of the AA 7021 recycled aluminum alloy was replaced with 24.1 wt % of an AA 7026 recycled aluminum alloy which did not contain other recycled aluminum alloy grades or components (AA 7026 being a designation under the Aluminum Association (AA) standard), and an amount of a respective one of the materials provided in this step was calculated based on a predetermined amount of a respective one of the target alloying elements in an AA 7026 aluminum alloy. The target alloying element added in the alloy composition conditioning step 24 and the primary pure aluminum ingot provided in the raw material selection and composition design step 21 were present in a total amount of 75.9 wt %, based on the weight of the conditioned aluminum alloy melt as 100 wt %. The AA 7026 recycled aluminum alloy was present in an amount of 24.1 wt %, based on a total weight of the CE2-AA 7026 as 100 wt %.

### Comparative Example 3-AA 7046 Regenerated Aluminum Alloy (CE3-AA 7046)

The procedures for preparing a medium strength AA 7046 regenerated aluminum alloy of CE3 (hereinafter abbreviated as CE3-AA 7046, AA 7046 being a designation under the Aluminum Association (AA) standard) were similar to those of the CE1-AA 7021, except that the materials and the amounts thereof for preparing the CE3-AA 7046 were varied as shown in Table 4 below. To be specific, in the raw material selection and composition design step 21, 44.6 wt % of the AA 7021 recycled aluminum alloy was replaced with 47.6 wt % of an AA 7046 recycled aluminum alloy which did not contain other recycled aluminum alloy grades or components (AA 7046 being a designation under the Aluminum Association (AA) standard), and an amount of a respective one of the materials provided in this step were calculated based on a predetermined amount of a respective one of the target alloying elements in an AA 7046 aluminum alloy. The target alloying element added in the alloy composition conditioning step 24 and the primary pure aluminum ingot provided in the raw material selection and composition design step 21 were present in a total amount of 52.4 wt %, based on the total weight of the conditioned aluminum alloy melt as 100 wt %. The AA 7046 recycled aluminum alloy was present in an amount of 47.6 wt %, based on a total weight of the CE3-AA 7046 as 100 wt %.

### Comparative Example 4-AA 7005 Regenerated Aluminum Alloy (CE4-AA 7005)

The procedures for preparing a medium strength AA 7005 regenerated aluminum alloy of CE4 (hereinafter abbreviated as CE4-AA 7005) were similar to those of the CE1-AA 7021, except that the materials and the amounts thereof for preparing the CE4-AA 7005 were varied as shown in Table 4 below. To be specific, in the raw material selection and composition design step 21, 44.6 wt % of the AA 7021 recycled aluminum alloy was replaced with 39.5 wt % of an AA 7005 recycled aluminum alloy which did not contain other recycled aluminum alloy grades or components, and an amount of a respective one of the materials provided in this step was calculated based on a predetermined amount of a respective one of the target alloying elements in an AA 7005 aluminum alloy. The target alloying element added in the alloy composition conditioning step 24 and the primary pure aluminum ingot provided in the raw material selection and composition design step 21 were present in a total amount of 60.5 wt %, based on the total weight of the conditioned aluminum alloy melt as 100 wt %. The AA 7005 recycled aluminum alloy was present in an amount of 39.5 wt %, based on a total weight of the CE4-AA 7005 as 100 wt %.

TABLE 2

| | | Target alloying elements | | | | | | | | |
|---|---|---|---|---|---|---|---|---|---|---|
| | | Si | Fe | Cu | Mn | Mg | Zn | Cr | Ti | Zr |
| | | Amount (wt %) | | | | | | | | |
| EX1-AA 7005 | | 0.08 | 0.14 | 0.08 | 0.24 | 1.5 | 4.7 | 0.11 | 0.027 | 0.12 |
| | Amount | | | | | | | | | |
| Material | (wt %) | | | | | | | | | |
| AA 7005 recycled | 28.7 | ≤0.10 | ≤0.15 | ≤0.05 | ≤0.30 | ≤1.8 | ≤5.0 | ≤0.15 | ≤0.03 | ≤0.15 |
| aluminum alloy | | | | | | | | | | |
| AA 5051 recycled | 14.3 | ≤0.2 | ≤0.2 | ≤0.05 | ≤0.08 | ≤2 | ≤0.01 | ≤0.05 | ≤0.03 | ≤0.001 |
| aluminum alloy | | | | | | | | | | |
| AA 6063 recycled | 29.5 | ≤0.08 | ≤0.06 | ≤0.02 | ≤0.06 | ≤0.3 | ≤0.1 | ≤0.03 | ≤0.025 | ≤0.001 |
| aluminum alloy | | | | | | | | | | |
| AA 7050 recycled | 9.1 | ≤0.04 | ≤0.04 | ≤0.5 | ≤0.02 | ≤1.0 | ≤4.0 | ≤0.015 | ≤0.03 | ≤0.15 |
| aluminum alloy | | | | | | | | | | |
| Primary pure | 18.4 | ≤0.04 | ≤0.05 | ≤0.001 | ≤0.001 | ≤0.001 | ≤0.001 | ≤0.001 | ≤0.005 | ≤0.001 |
| aluminum ingot | | | | | | | | | | |
| Target alloying | | Trace amount of pure Mg, pure Zn, pure Cu, Fe cake, Mn cake, Ti | | | | | | | | |
| element added | | cake, Cr cake, and Zr master alloy | | | | | | | | |
| in alloy | | | | | | | | | | |
| composition | | | | | | | | | | |
| conditioning | | | | | | | | | | |
| step | | | | | | | | | | |

TABLE 3

| | | Target alloying elements | | | | | | | | |
|---|---|---|---|---|---|---|---|---|---|---|
| | | Si | Fe | Cu | Mn | Mg | Zn | Cr | Ti | Zr |
| | | Amount (wt %) | | | | | | | | |
| EX2-AA 7046 | | 0.09 | 0.14 | 0.23 | 0.14 | 1.2 | 7.0 | 0.09 | 0.027 | 0.13 |
| | Amount | | | | | | | | | |
| Material | (wt %) | | | | | | | | | |
| AA 7046 recycled | 29.1 | ≤0.10 | ≤0.15 | ≤0.2 | ≤0.15 | ≤1.6 | ≤7.6 | ≤0.02 | ≤0.025 | ≤0.16 |
| aluminum alloy | | | | | | | | | | |
| AA 5051 recycled | 16.3 | ≤0.2 | ≤0.2 | ≤0.05 | ≤0.08 | ≤2 | ≤0.01 | ≤0.05 | ≤0.03 | ≤0.001 |
| aluminum alloy | | | | | | | | | | |
| AA 6063 recycled | 27.0 | ≤0.08 | ≤0.06 | ≤0.02 | ≤0.06 | ≤0.3 | ≤0.1 | ≤0.03 | ≤0.025 | ≤0.001 |
| aluminum alloy | | | | | | | | | | |
| AA 7050 recycled | 22.5 | ≤0.04 | ≤0.04 | ≤0.5 | ≤0.02 | ≤1.0 | ≤4.0 | ≤0.015 | ≤0.03 | ≤0.15 |
| aluminum alloy | | | | | | | | | | |
| Primary pure | 5.1 | ≤0.04 | ≤0.05 | ≤0.001 | ≤0.001 | ≤0.001 | ≤0.001 | ≤0.001 | ≤0.005 | ≤0.001 |
| aluminum ingot | | | | | | | | | | |
| Target alloying | | Trace amount of pure Mg, pure Zn, pure Cu, Fe cake, Mn cake, Ti | | | | | | | | |
| element added | | cake, Cr cake, and Zr master alloy | | | | | | | | |
| in alloy | | | | | | | | | | |
| composition | | | | | | | | | | |
| conditioning | | | | | | | | | | |
| step | | | | | | | | | | |

TABLE 4

| | | Primary pure aluminum |
|---|---|---|
| | | ingot providing in raw |
| | | material selection and |
| | | composition design step |
| | | and target alloying |
| | Recycled | element added in alloy |
| Regenerated | aluminum | composition conditioning |
| aluminum | alloy | step |
| alloy | Amount (wt %) | |
| CE1-AA 7021 | 44.6 wt % of AA 7021 | 55.4 |
| | recycled aluminum | |
| | alloy | |
| CE2-AA 7026 | 24.1 wt % of AA 7026 | 75.9 |
| | recycled aluminum | |
| | alloy | |
| CE3-AA 7046 | 47.6 wt % of AA 7046 | 52.4 |
| | recycled aluminum | |
| | alloy | |
| CE4-AA 7005 | 39.5 wt % of AA 7005 | 60.5 |
| | recycled aluminum | |
| | alloy | |

### Property Evaluation

### A. Preparation of Test Specimen

Each of the EX1-AA 7005, EX2-AA 7046, CE1-AA 7021, CE2-AA 7026, CE3-AA 7046, and CE4-AA 7005 was subjected to a T6 heat treatment, followed by machining along a direction parallel to the extrusion direction, so as to obtain a test specimen of each of EX1, EX2, and CE1 to CE4, each having a rectangular shape in accordance with the procedures set forth in ASTM B557M-15 for the following tensile testing or having a square shape for the following electrochemical measurement.

### B. Tensile Testing for Determination of Ultimate Tensile Strength, Tensile Yield Strength, and Elongation

One test specimen with the rectangular shape for each of EX1, EX2, and CE1 to CE4 prepared as described in section A of “Property evaluation” was subjected to determination of ultimate tensile strength (UTS), tensile yield strength (TYS), and elongation (EL) in accordance with the procedures set forth in ASTM B557M-15. The results are shown in Table 5 below.

### C. Electrochemical Measurement for Determination of Corrosion Potential and Corrosion Current

First, one test specimen with the square shape for each of EX1, EX2, and CE1 to CE4 prepared as described in section A of “Property evaluation” was polished to a mirror finish using a polishing solution that included 50 nm of silicon dioxide, followed by leaving the test specimen in a sodium chloride solution that included 3.5 wt % of sodium chloride and that served as an electrolyte to stand for 30 minutes.

Next, the test specimen in the sodium chloride solution was subjected to determination of corrosion potential (E_{corr.}) and corrosion current (I_{corr.}) using a potentiostat at a scan rate of 1 mV/s. To be specific, the potentiostat had an AgCl electrode (serving as a reference electrode) and a carbon electrode (serving as a counter electrode). The results are shown in Table 6 below.

### Results

TABLE 5

| Regenerated | | | |
|---|---|---|---|
| aluminum alloy | TYS (MPa) | UTS (MPa) | EL (%) |
| CE1-AA 7021 | 410.7 ± 2.5 | 442.0 ± 2.0 | 17.9 ± 0.6 |
| CE2-AA 7026 | 341.0 ± 1.0 | 378.7 ± 2.3 | 17.0 ± 0.6 |
| CE3-AA 7046 | 463.5 ± 6.2 | 505.3 ± 3.0 | 15.4 ± 0.5 |
| CE4-AA 7005 | 425.7 ± 3.8 | 455.3 ± 2.3 | 14.8 ± 0.1 |
| EX1-AA 7005 | 410.2 ± 1.4 | 460.8 ± 1.7 | 18.5 ± 0.5 |
| EX2-AA 7046 | 496.3 ± 4.0 | 540.8 ± 0.7 | 18.6 ± 0.5 |

TABLE 6

| Regenerated | Corrosion potential | Corrosion current |
|---|---|---|
| aluminum alloy | (E_{corr.}, unit: V) | (I_{corr.}, unit: μA/cm²) |
| CE1-AA 7021 | −1.187 | 1.23 |
| CE2-AA 7026 | −1.218 | 2.65 |
| CE3-AA 7046 | −1.275 | 8.81 |
| CE4-AA 7005 | −1.109 | 2.51 |
| EX1-AA 7005 | −1.041 | 1.23 |
| EX2-AA 7046 | −1.140 | 9.11 |

Referring to Tables 2 and 3, the amounts of the respective one of the target alloying elements in each of the EX1-AA 7005 and the EX2-AA 7046 were able to meet the amount of the respective one of the target alloying elements in each of the commercially available medium strength AA 7005 aluminum alloy and the commercially available medium strength AA 7046 aluminum alloy, respectively, as shown in Table 1. In addition, the recycled aluminum alloys in the EX1-AA 7005 and the EX2-AA 7046 were present in amounts of 81.6 wt % and 94.9 wt %, respectively, based on a respective total weight of the EX1-AA 7005 and the EX2-AA 7046. These results demonstrate that the medium strength 7xxx series regenerated aluminum alloy (e.g., the EX1-AA 7005 and the EX2-AA 7046) prepared by the method of the present disclosure exhibits a significant increase in the amounts of the recycled aluminum alloys, and is capable of overcoming the problem of low recyclability in conventional medium strength 7xxx series regenerated aluminum alloys, which has traditionally limited amounts of the recycled aluminum alloys in this series.

Conventional medium strength 7xxx series aluminum alloys, such as AA 7003, AA 7005, AA 7021, and AA 7046, can achieve an ultimate tensile strength (UTS) approximately ranging from 350 MPa to 550 MPa after T6 heat treatment. Referring to Table 5, under the same conditions of the T6 heat treatment, the UTS of a respective one of the EX1-AA 7005 and EX2-AA 7046 was fully comparable to that of the conventional medium strength 7xxx series aluminum alloys. Furthermore, compared with a respective one of the CE1-AA 7021, CE2-AA 7026, CE3-AA 7046, and CE4-AA 7005 which were prepared from a single type of the recycled aluminum alloy (i.e., the AA 7021, AA7026, AA 7046, or AA 7005 recycled aluminum alloy) and which met a predetermined amount of a respective one of the target alloying elements in the same conventional aluminum alloy grade, the respective one of the EX1-AA 7005 and EX2-AA 7046 exhibited equivalent mechanical properties (i.e., the TYS, UTS, and EL) and electrochemical properties (i.e., corrosion potential and corrosion current). These results indicate that the medium strength 7xxx series regenerated aluminum alloy (e.g., the EX1-AA 7005 and the EX2-AA 7046) prepared by the method of the present disclosure not only has a relatively high amount of the recycled aluminum alloys, but also has mechanical and electrochemical properties comparable to those of conventional medium strength 7xxx series aluminum alloys.

Summarizing the above test results, by virtue of using the 5xxx series recycled aluminum alloy and/or the 6xxx series recycled aluminum alloy, which are respectively sourced from 5xxx and 6xxx series aluminum alloys having relatively high market demand and abundant sources of recycling and which serve as the primary component in the method of the present disclosure, the medium strength 7xxx series regenerated aluminum alloy thus obtained includes the recycled aluminum alloys present in an amount not lower than 75 wt %, based on the total weight of the medium strength 7xxx series regenerated aluminum alloy as 100 wt %, and hence has relatively high amount of the recycled aluminum alloys which are of different series from the medium strength 7xxx series regenerated aluminum alloy. Therefore, the method of the present disclosure is capable of overcoming challenges of low amounts of the recycled aluminum alloys in regenerated products of the conventional medium strength 7xxx series aluminum alloys due to relatively dispersed applications thereof (such as automotive structural materials, sporting goods, consumer electronics, etc.), which leads to a relatively lower recycling rate and difficulty in sourcing the recycled aluminum alloys with similar target alloying elements. Furthermore, by virtue of the purification and refining step 22 and the alloy composition conditioning step 24 of the method of the present disclosure, precise control of the target alloying elements in the medium strength 7xxx series regenerated aluminum alloy thus obtained can be achieved. As a result, despite the recycled aluminum alloys being present in an amount not lower than 75 wt % based on the total weight of the medium strength 7xxx series regenerated aluminum alloy as 100 wt %, the medium strength 7xxx series regenerated aluminum alloy prepared from the method of the present disclosure has the mechanical and electrochemical properties comparable to those of the conventional medium strength 7xxx series aluminum alloys which have relatively low amounts of recycled aluminum alloys.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, the one or more features may be singled out and practiced alone without the another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for preparing a medium strength 7xxx series regenerated aluminum alloy, comprising:
a raw material selection and composition design step of providing a primary pure aluminum ingot, a first recycled aluminum alloy, a second recycled aluminum alloy, and a third recycled aluminum alloy, each of the first recycled aluminum alloy and the second recycled aluminum alloy being selected from the group consisting of a 5xxx series recycled aluminum alloy and a 6xxx series recycled aluminum alloy, the third recycled aluminum alloy being selected from the group consisting of a 5xxx series recycled aluminum alloy, a 6xxx series recycled aluminum alloy, a 1xxx series recycled aluminum alloy, a 7xxx series recycled aluminum alloy, and a combination thereof,
wherein each of the first recycled aluminum alloy, the second recycled aluminum alloy, and the third recycled aluminum alloy contains target alloying elements, and
wherein amounts of the first recycled aluminum alloy, the second recycled aluminum alloy, the third recycled aluminum alloy, and the primary pure aluminum ingot are calculated based on a predetermined amount of a respective one of the target alloying elements in a medium strength 7xxx series aluminum alloy which has a grade same as a grade of the medium strength 7xxx series regenerated aluminum alloy;
a purification and refining step of purifying and refining at least one of the first recycled aluminum alloy, the second recycled aluminum alloy, and the third recycled aluminum alloy containing the target alloying elements provided in the raw material selection and composition design step to remove a portion of at least one of the target alloying elements from the at least one of the first recycled aluminum alloy, the second recycled aluminum alloy, and the third recycled aluminum alloy based on the predetermined amount of the respective one of the target alloying elements in the medium strength 7xxx series aluminum alloy, so as to obtain a refined recycled aluminum material containing the target alloying elements, a remaining portion of the first recycled aluminum alloy, the second recycled aluminum alloy, and the third recycled aluminum alloy being an unrefined recycled aluminum material that contains the target alloying elements after the at least one of the first recycled aluminum alloy, the second recycled aluminum alloy, and the third recycled aluminum alloy has undergone the purification and refining step;
a melting step of melting the primary pure aluminum ingot provided in the raw material selection and composition design step, the unrefined recycled aluminum material, and the refined recycled aluminum material obtained in the purification and refining step into an aluminum alloy melt containing the target alloying elements, an amount of a respective one of the target alloying elements in the aluminum alloy melt being not greater than the predetermined amount of the respective one of the target alloying elements in the medium strength 7xxx series aluminum alloy;
an alloy composition conditioning step of adjusting the amount of the respective one of the target alloying elements in the aluminum alloy melt obtained in the melting step to fall within the predetermined amount of the respective one of the target alloying elements in the medium strength 7xxx series aluminum alloy, so as to obtain a conditioned aluminum alloy melt, the first recycled aluminum alloy, the second recycled aluminum alloy, and the third recycled aluminum alloy in the conditioned aluminum alloy melt being present in an amount not lower than 75 wt %, based on a total weight of the conditioned aluminum alloy melt as 100 wt %; and
a casting step of subjecting the conditioned aluminum alloy melt obtained in the alloy composition conditioning step to a casting treatment, so as to obtain the medium strength 7xxx series regenerated aluminum alloy containing the predetermined amount of the respective one of the target alloying elements.

2. The method as claimed in claim 1, wherein the third recycled aluminum alloy is selected from the group consisting of a 1xxx series recycled aluminum alloy, a 7xxx series recycled aluminum alloy, and a combination thereof.

3. The method as claimed in claim 2, wherein the 1xxx series recycled aluminum alloy is selected from the group consisting of a 1050 recycled aluminum alloy, a 1070 recycled aluminum alloy, a 1100 recycled aluminum alloy, and combinations thereof.

4. The method as claimed in claim 2, wherein the 7xxx series recycled aluminum alloy is selected from the group consisting of a 7050 recycled aluminum alloy, a 7150 recycled aluminum alloy, an recycled aluminum alloy having the grade same as the grade of the medium strength 7xxx series regenerated aluminum alloy obtained in the casting step, and combinations thereof.

5. The method as claimed in claim 1, wherein the 5xxx series recycled aluminum alloy is selected from the group consisting of a 5050 recycled aluminum alloy, a 5051 recycled aluminum alloy, a 5056 recycled aluminum alloy, and combinations thereof.

6. The method as claimed in claim 1, wherein the 6xxx series recycled aluminum alloy is selected from the group consisting of a 6060 recycled aluminum alloy, a 6061 recycled aluminum alloy, a 6063 recycled aluminum alloy, and combinations thereof.

7. The method as claimed in claim 1, wherein the purification and refining step is selected from the group consisting of a boron treatment, a segregation purification treatment, and a combination thereof.

8. The method as claimed in claim 1, wherein in the casting step, the conditioned aluminum alloy melt obtained in the alloy composition conditioning step is further subjected to an extrusion treatment after the casting treatment.

9. The method as claimed in claim 1, wherein the conditioned aluminum alloy melt includes, based on the total weight of the conditioned aluminum alloy melt as 100 wt %: not greater than 0.15 wt % of silicon; not greater than 0.20 wt % of iron; not greater than 0.4 wt % of copper; not greater than 0.30 wt % of manganese; 0.5 wt % to 2.0 wt % of magnesium; 4.0 wt % to 8.0 wt % of zinc; not greater than 0.2 wt % of chromium; not greater than 0.06 wt % of titanium; not greater than 0.25 wt % of zirconium; and aluminum which makes up the balance.

10. A medium strength 7xxx series regenerated aluminum alloy prepared by the method as claimed in claim 1, comprising a first recycled aluminum alloy, a second recycled aluminum alloy, and a third recycled aluminum alloy present in an amount not lower than 75 wt %, based on a total weight of the medium strength 7xxx series regenerated aluminum alloy as 100 wt %, the medium strength 7xxx series regenerated aluminum alloy having an ultimate tensile strength (UTS) ranging from 350 MPa to 550 MPa, a tensile yield strength (TYS) ranging from 300 MPa to 500 MPa, and an elongation (EL) greater than 10% at T6 heat treatment condition.

11. The medium strength 7xxx series regenerated aluminum alloy as claimed in claim 10, which includes, based on the total weight of the medium strength 7xxx series regenerated aluminum alloy as 100 wt %: not greater than 0.15 wt % of silicon; not greater than 0.20 wt % of iron; not greater than 0.4 wt % of copper; not greater than 0.30 wt % of manganese; 0.5 wt % to 2.0 wt % of magnesium; 4.0 wt % to 8.0 wt % of zinc; not greater than 0.2 wt % of chromium; not greater than 0.06 wt % of titanium; not greater than 0.25 wt % of zirconium; and aluminum which makes up the balance.
